(19) United States
(12) Patent Application Publication
(10) Pub. No.: US 2022/0084056 A1
(43) Pub. Date: Mar. 17, 2022

(54) METHODS AND APPARATUSES FOR MANAGING VISITOR INFORMATION, ELECTRONIC DEVICES AND STORAGE MEDIA

(71) Applicant: Beijing Sensetime Technology Development Co., Ltd., Beijing (CN)

(72) Inventor: Xueqi ZHOU, Beijing (CN)

(21) Appl. No.: 17/538,565

(22) Filed: Nov. 30, 2021

Related U.S. Application Data
(63) Continuation of application No. PCT/CN2020/113283, filed on Sep. 3, 2020.

(30) Foreign Application Priority Data
Nov. 15, 2019 (CN) 201911122095.3

(51) Int. Cl. G06Q 30/02; G06V 40/10; G06V 20/40; G06V 10/762; G06T 7/73; G06V 10/74

(52) U.S. Cl. CPC G06Q 30/0204; G06V 40/103; G06V 20/40; G06T 2207/30196; G06T 7/73; G06V 10/761; G06T 2207/10016; G06V 10/762

(57) ABSTRACT

Methods, devices, apparatuses, systems, and computer-readable storage media for managing visitor information are provided. In one aspect, a method includes: receiving a follow-up request for a target visitor included in unfollowed-up visitors in a visitor list, obtaining information of accompanying persons of the target visitor from a server-side computing system in response to the follow-up request, establishing a visitor group including the target visitor based on the target visitor and the accompanying persons of the target visitor to associate information of multiple visitors in the visitor group, and displaying the information of multiple visitors in the visitor group.

### CROSS-REFERENCE TO RELATED APPLICATION

The present application is a continuation of International Application No. PCT/CN2020/113283 filed on Sep. 3, 2020, which claims priority to Chinese Patent Application No. 201911122095.3 filed on Nov. 15, 2019. The entirety of the above-referred applications are hereby incorporated by reference.

### TECHNICAL FIELD

The present disclosure relates to the field of computer technology, in particular to methods and apparatuses for managing visitor information, electronic devices and storage media.

### BACKGROUND

In some high-net-worth retail scenarios such as vehicles, buildings, and jewelry, a staff member such as a salesperson usually receives multiple visitors who visit together, where the relationship of the multiple visitors can include husband and wife, parents and children, friends, etc.

Usually, one or two orders/transactions in a subsequent follow-up process can be completed for the multiple visitors who visit together, which means that for high-net-worth retail scenarios, multiple visitors who visit together often have same or similar purchase intention, and eventually a transaction can be completed by taking the group as a unit.

### SUMMARY

The present disclosure provides a visitor information management technical solution for managing visitors, to reduce customer information omissions and cases in which multiple salespersons are assigned to a same customer for follow-up.

According to an aspect of the present disclosure, there is provided a method for managing visitor information, including: receiving a follow-up request for a target visitor by a client-side computing system, where the target visitor is included in unfollowed-up visitors in a visitor list; obtaining information of accompanying persons of the target visitor from a server-side computing system in response to the follow-up request by the client-side computing system; establishing a visitor group including the target visitor based on the target visitor and the accompanying persons of the target visitor to associate information of multiple visitors in the visitor group by the client-side computing system; and displaying the information of multiple visitors in the visitor group by the client-side computing system.

In some examples, establishing the visitor group including the target visitor based on the target visitor and the accompanying persons of the target visitor includes: displaying the information of the accompanying persons of the target visitor by the client-side computing system; and in response to a first operation of selecting a target accompanying person from the accompanying persons of the target visitor, adding the target accompanying person to the visitor group by the client-side computing system.

In some examples, establishing the visitor group including the target visitor based on the target visitor and the accompanying persons of the target visitor includes: adjusting the visitor group for the target visitor according to visit data of the unfollowed-up visitors in the visitor list.

In some examples, adjusting the visitor group for the target visitor according to the visit data of the unfollowed-up visitors in the visitor list includes: displaying information of the unfollowed-up visitors in the visitor list by the client-side computing system; and in response to a second operation of selecting a target unfollowed-up visitor, adding the target unfollowed-up visitor to the visitor group by the client-side computing system.

In some examples, displaying the information of the unfollowed-up visitors in the visitor list by the client-side computing system includes: obtaining visit time of the unfollowed-up visitors in the visitor list from the server-side computing system; and displaying the information of the unfollowed-up visitors in the visitor list according to the visit time of the unfollowed-up visitors by the client-side computing system, where the unfollowed-up visitors in the visitor list are arranged according to at least one of the visit time of the unfollowed-up visitors or a similarity between the visit time of the unfollowed-up visitors and a visit time of the target visitor.

In some examples, after establishing the visitor group including the target visitor based on the target visitor and the accompanying persons of the target visitor, the method further includes: determining a decision maker in the visitor group according to visit data of at least one visitor in the visitor group by the client-side computing system.

In some examples, where the decision maker includes at least one of: a visitor in the visitor group with a visit frequency greater than a first threshold, a visitor in the visitor group with a recorded visitor data volume greater than a second threshold, or a visitor in the visitor group with a number of visits greater than a third threshold.

In some examples, the accompanying persons of the target visitor are determined by the server-side computing system according to trajectory information of multiple persons, and where the server-side computing system is configured to: perform a person detection on video images captured by a plurality of image capturing devices deployed in different regions to obtain a person detection result; determine an image set corresponding to at least one of the multiple persons based on a result of performing the person detection, where the image set corresponding to the at least one of the multiple persons includes a person image of the at least one of the multiple persons; and determine trajectory information of the at least one of the multiple persons according to position information of the plurality of image capturing devices, the image set corresponding to the at least one of the multiple persons, and a time at which the person image is captured.

In some examples, the server-side computing system is configured to determine the accompanying persons of the target visitor according to the trajectory information of the multiple persons by: clustering the trajectory information of the multiple persons to obtain a cluster set including trajectory information of the target visitor; and determining persons corresponding to multiple groups of trajectory information in the cluster set as a group of accompanying persons.

In some examples, the server-side computing system is configured to determine the trajectory information of the at least one person by: for at least one person image in the image set corresponding to the at least one of the multiple persons, determining first position information of a target person in the at least one person image in video images corresponding to the at least one person image; determining a spatial position coordinate of the target person in a spatial coordinate system based on the first position information and second position information, where the second position information is position information of image capturing devices for capturing the video images corresponding to the at least one person image; obtaining a spatiotemporal position coordinate of the target person in a spatiotemporal coordinate system according to the spatial position coordinate and time when the video images corresponding to the at least one person image are captured; and obtaining the trajectory information of the at least one of the multiple persons in the spatiotemporal coordinate system based on spatiotemporal position coordinates of the multiple persons.

In some examples, the trajectory information of the at least one of the multiple persons includes point groups in the spatiotemporal coordinate system, and where the server-side computing system is configured to determine the accompanying persons of the target visitor according to the trajectory information of the multiple persons by: for each two persons of the multiple persons, determining a similarity for point groups corresponding to the two persons in the spatiotemporal coordinate system in the trajectory information of the multiple persons; determining multiple person pairs based on a comparison between the similarity and a first similarity threshold, where each of the multiple person pairs includes two persons, and a value of the similarity of each of the multiple person pairs is greater than the first similarity threshold; and determining the accompanying persons of the target visitor based on the multiple person pairs.

In some examples, the server-side computing system is configured to determine the accompanying persons of the target visitor based on the multiple person pairs by: establishing an accompanying person set based on a first person pair in the multiple person pairs, where the first person pair includes the target visitor; determining an associated person pair from at least one second person pair of the multiple person pairs other than a person pair included in the accompanying person set, where the associated person pair includes at least one person in the accompanying person set; adding the associated person pair into the accompanying persons set; and determining persons other than the target visitor in the accompanying person set as the accompanying persons of the target visitor.

In some examples, the server-side computing system is configured to add the associated person pair into the accompanying person set by: determining a number of person pairs including a first person in the associated person pair; and in response to determining that the number of person pairs including the first person is less than a person pair number threshold, adding the associated person pair into the accompanying person set.

In some examples, after determining the accompanying persons of the target visitor based on the multiple person pairs, the server-side computing system is further configured to: in response to determining that a number of persons in the accompanying persons of the target visitor is greater than a first number threshold, determine at least one of the multiple person pairs with a similarity greater than a second similarity threshold to be a group of accompanying persons, such that the number of persons in the group of accompanying persons is less than the first number threshold, where the second similarity threshold is greater than the first similarity threshold.

In some examples, the server-side computing system is configured to, for each two persons of the multiple persons, determine the similarity for the point groups corresponding to the two persons in the spatiotemporal coordinate system in the trajectory information of the multiple persons by: for a first person and a second person in the two persons, determining a spatial distance between at least one first spatiotemporal position coordinate corresponding to the first person in the spatiotemporal coordinate system and at least one second spatiotemporal position coordinate corresponding to the second person in the spatiotemporal coordinate system; determining a first number of first spatiotemporal position coordinates corresponding to the spatial distance less than or equal to a distance threshold, and a second number of second spatiotemporal position coordinates corresponding to the spatial distance less than or equal to the distance threshold; determining a first ratio of the first number to a total number of the at least one first spatiotemporal position coordinate, and a second ratio of the second number to a total number of the at least one second spatiotemporal position coordinate; and determining a maximum value of the first ratio and the second ratio as the similarity of the two persons.

According to an aspect of the present disclosure, there is provided a system, including: at least one processor; and one or more memories coupled to the at least one processor and storing programming instructions for execution by the at least one processor to perform operations including: receiving a follow-up request for a target visitor, where the target visitor is included in unfollowed-up visitors in a visitor list; obtaining information of accompanying persons of the target visitor from a server-side computing system in response to the follow-up request; establishing a visitor group including the target visitor based on the target visitor and the accompanying persons of the target visitor to associate information of multiple visitors in the visitor group; and displaying the information of multiple visitors in the visitor group.

According to an aspect of the present disclosure, there is provided system, including: at least one processor; and one or more memories coupled to the at least one processor and storing programming instructions for execution by the at least one processor to perform operations including: receiving a follow-up request for a target visitor, where the target visitor is included in unfollowed-up visitors in a visitor list; obtaining information of accompanying persons of the target visitor from a server-side computing system in response to the follow-up request; establishing a visitor group including the target visitor based on the target visitor and the accompanying persons of the target visitor to associate information of multiple visitors in the visitor group; and displaying the information of multiple visitors in the visitor group.

In some examples, establishing the visitor group including the target visitor based on the target visitor and the accompanying persons of the target visitor includes: displaying the information of accompanying persons of the target visitor; and in response to a first operation of selecting a target accompanying person from the accompanying persons of the target visitor, adding the target accompanying person to the visitor group.

In some examples, establishing the visitor group including the target visitor based on the target visitor and the accompanying persons of the target visitor includes: adjusting the visitor group for the target visitor according to visit data of the unfollowed-up visitors in the visitor list.

In some examples, adjusting the visitor group for the target visitor according to the visit data of the unfollowed-up visitors in the visitor list includes: displaying information of the unfollowed-up visitors in the visitor list; and in response to a second operation of selecting a target unfollowed-up visitor, adding the target unfollowed-up visitor to the visitor group

According to an aspect of the present disclosure, there is provided a non-transitory computer-readable storage medium coupled to at least one processor having machine-executable instructions stored thereon that, when executed by the at least one processor, cause the at least one processor to perform operations including: receiving a follow-up request for a target visitor, where the target visitor is included in unfollowed-up visitors in a visitor list; obtaining accompanying persons of the target visitor from a server-side computing system in response to the follow-up request; establishing a visitor group including the target visitor based on the target visitor and the accompanying persons of the target visitor to associate information of multiple visitors in the visitor group; and displaying the information of multiple visitors in the visitor group.

According to an aspect of the present disclosure, there is provided a computer program including computer readable codes, where when the computer readable codes are run in an electronic device, the above method is performed by a processor in the electronic device.

In this way, through the interaction between the client and the server-side, the information of accompanying person(s) of the target visitor can be obtained based on the received follow-up request for the target visitor, and then the visitor group for the target visitor can be established according to the target visitor and the accompanying person(s) of the target visitor. According to the visitor information management method provided by the present disclosure, the visitor group can be established for visitors who visit together and visitors can be managed through the visitor group. In this way, customer information omissions and cases in which multiple salespersons are assigned to a same customer for follow-up can be effectively reduced. In addition, the data to determine the visitor group is the accompanying person data (e.g., including at least data of a group of accompanying persons to which the target visitor belongs) provided by the server-side. In this way, cases in which partial visitors are omitted due to manually determining the visitor group can be reduced, thereby improving the customer experience of the visitors, and implementing targeted management of the visitors.

It should be understood that the above general description and the following detailed description are only exemplary and explanatory, rather than limiting the present disclosure. Other features and aspects of the present disclosure will become apparent from the following detailed description of exemplary embodiments with reference to the accompanying drawings.

### BRIEF DESCRIPTION OF THE DRAWINGS

The accompanying drawings here are incorporated into the specification and constitute a part of the specification. These accompanying drawings show embodiments that conform to the present disclosure, and are intended to describe the technical solutions in the present disclosure together with the specification.

FIG. 1 illustrates a flowchart of a method for managing visitor information according to one or more embodiments of the present disclosure.

FIG. 2 illustrates a schematic diagram of an exemplary interface according to one or more embodiments of the present disclosure.

FIG. 3 illustrates a schematic diagram of an exemplary interface according to one or more embodiments of the present disclosure.

FIG. 4 illustrates a schematic diagram of an exemplary interface according to one or more embodiments of the present disclosure.

FIG. 5 illustrates a block diagram of an apparatus for managing visitor information according to one or more embodiments of the present disclosure.

FIG. 6 illustrates a block diagram of an electronic device according to one or more embodiments of the present disclosure.

FIG. 7 illustrates a block diagram of another electronic device according to one or more embodiments of the present disclosure.

### DETAILED DESCRIPTION OF THE EMBODIMENTS

Various exemplary embodiments, features, and aspects of the present disclosure will be described in detail below with reference to the accompanying drawings. Like reference numerals in the drawings indicate elements with the same or similar functions. Although various aspects of the embodiments are shown in the drawings, unless otherwise noted, the drawings are not necessarily drawn to scale.

The dedicated word “exemplary” here means “serving as an example, embodiment, or illustration.” Any embodiment described herein as “exemplary” needs not be construed as being superior or better than other embodiments.

The term “and/or” herein is merely an association relationship describing an associated object, and indicates that there may be three relationships. For example, A and/or B may indicate that there are three cases: A alone, both A and B, and B alone. In addition, the term “at least one” herein denotes any one of a plurality or any combination of at least two of a plurality. For example, at least one of A, B, or C may denote any one or more elements selected from the set consisting of A, B, and C.

In addition, in order to better illustrate the present disclosure, numerous specific details are given in the following detailed description. Those skilled in the art should understand that the present disclosure can also be implemented without certain specific details. In some examples, the methods, means, elements, and circuits well-known to those skilled in the art have not been described in detail in order to highlight the subject matter of the present disclosure.

Taking a salesperson as an example, for multiple visitors who visit together, in an existing follow-up mechanism, the salesperson often serves the multiple visitors who visit together at the same time, and because the number of visitors who visit together is usually relatively large (such as, four to six persons), it is difficult for the salesperson to record and associate information of all visitors in time, which leads to visitor information omissions, and even reassignment of salespersons in a case of second visits of some visitors. In the embodiments of the present disclosure, through an interaction between a client (e.g., a client-side computing device or system) and a server-side (e.g., a server-side computing device or system), a follow-up request for a target visitor is received, information of accompanying persons of the target visitor are obtained, and then a visitor group for the target visitor is established based on the target visitor and the accompanying persons of the target visitor. In this way, cases in which partial visitors are omitted due to manually determining the visitor group can be reduced, thereby improving the customer experience of the visitors and implementing targeted management of the visitors.

FIG. 1 illustrates a flowchart of a method for managing visitor information according to one or more embodiments of the present disclosure. In a possible implementation, the method for managing visitor information can be performed by a client. The client can be a client-side computing system including one or more computing devices. In some embodiments, the client includes an electronic device such as a terminal device or a server, and the terminal device can include a user equipment (UE), a mobile device, a user terminal, a cellular phone, a cordless phone, a personal digital assistant (PDA), a handheld device, a computing device, an on-board device, a wearable device, etc. The method can be implemented by a processor calling computer-readable instructions stored in a memory. Alternatively, the method can be performed by a server.

As shown in FIG. 1, the method for managing visitor information may include steps S11 to S13.

At step S11, a follow-up request for a target visitor is received, where the target visitor is included in unfollowed-up visitors in a visitor list.

For example, the follow-up request may include a request generated when a follow-up operation is detected, and the follow-up operation may include a trigger operation for a corresponding control. For example, if a current user is a salesperson, and the salesperson attempts to follow up the target visitor, that is, to obtain related information of the target visitor and/or to provide sales services to the target visitor (for example, to serve the target visitor for an entire purchase cycle), the salesperson can trigger a control for generating a follow-up request to generate the follow-up request for the target visitor, which is received by the terminal device. It should be noted that the user can trigger the control for generating a follow-up request by clicking, sliding and other operations, and/or by inputting a voice message, etc., to generate the follow-up request.

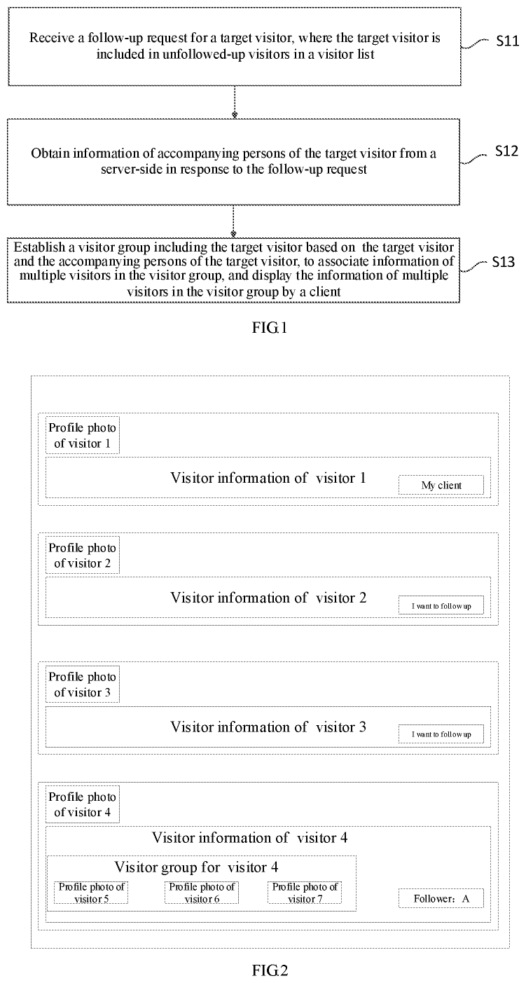

FIG. 2 illustrates a schematic diagram of an exemplary interface according to the present disclosure.

Exemplarily, the visitor list may include followed-up visitors and the unfollowed-up visitors. As shown in FIG. 2, the current user is a salesperson, and the visitor list displayed on the terminal device may include the visitor information of multiple visitors who visited within a preset time period, where the visitor information includes an identifier representing whether a visitor has been followed up by a salesperson (that can be the current user or a salesperson other than the current user, etc.). If the visitor is not followed up by any salesperson, the visitor can be regarded as a target visitor, and a salesperson can generate a follow-up request for the target visitor by triggering a corresponding control on the terminal device (for example, triggering the “I want to follow up” button (e.g., a control) shown in FIG. 2).

At step S12, information of the accompanying persons of the target visitor are obtained from a server-side in response to the follow-up request.

For example, the server-side can pre-determine the accompanying persons of the target visitor. The specific process thereof will be described below in detail, and is not described herein. The server-side is an end with a capability of processing big data. The server-side can be a server-side computing system that includes one or more computing devices. In some embodiments, the server-side includes a server, a terminal device, a cloud, etc. After receiving the follow-up request, the client can obtain the information of accompanying persons of the target visitor from the server-side. For example, a request for obtaining the information of accompanying persons can be sent to the server-side, and the request carries an identifier of the target visitor (for example: an ID, a name, a phone number and other information that can uniquely identify the identity of the target visitor). After receiving the request, the server-side can obtain the information of accompanying person of the target visitor, and send the accompanying person information to the client. The accompanying person information may include the information of the target visitor and the accompanying persons of the target visitor, specifically, a name, a visit record and other information of the target visitor and/or at least one accompanying person of the target visitor. After receiving the accompanying person information sent by the server-side, the client can display the information of the target visitor and the accompanying persons of the target visitor based on the accompanying person information.

At step S13, a visitor group including the target visitor is established based on the target visitor and the accompanying persons of the target visitor, to associate information of multiple visitors in the visitor group, and the information of multiple visitors in the visitor group is displayed by a client.

For example, the visitor group for the target visitor may be established, and the visitor group for the target visitor includes at least the target visitor and a part or all of the accompanying persons of the target visitor. It should be noted that, considering that there may be misdetection in a process of determining the accompanying persons, for example, detected accompanying persons of the target visitor include a person who is not an accompanying person, determined accompanying persons can be filtered according to the actual situation, to add persons who are actually accompanying persons of the target visitor into the visitor group, thereby facilitating effective management of the visitor information. After the visitor group for the target visitor is established, the information of at least one visitor in the visitor group can be associated, so that when the visitor information of one of visitors is viewed, the information of other visitors in the visitor group can be associated. Exemplarily, as shown in FIG. 2, in the case of displaying visitor information of a visitor in the visitor group in the visitor list, the visitor information may include visitor information of other visitors in the visitor group (for example, a part or all of the visitor information is displayed, and in FIG. 2, considering a limited region in a display interface for displaying the visitor information of the other visitors, displaying a part of the visitor information is taken as an example), such as visitor 4 in FIG. 2.

In a possible implementation, the visitor information of visitors in the visitor group can be edited. For example, editable visitor information includes but is not limited to a combination of one or more of the following: a name, contact information, a consumption possibility level, etc. The visitor information that can be viewed includes but is not limited to a combination of one or more of the following: a name, contact information, a consumption possibility level, a type of a product of interest and an accumulated attention time, the number of visits and time of each visit and/or a duration of stay of each visit, accompanying persons, etc. The consumption possibility level refers to the labeling of a consumption intention of a visitor, for example, for a visitor with a higher consumption intention, his/her consumption possibility level is higher.

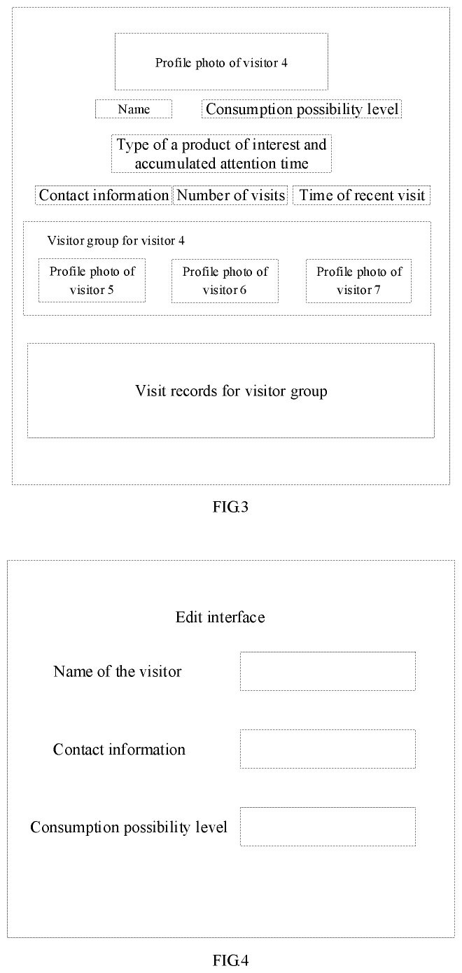

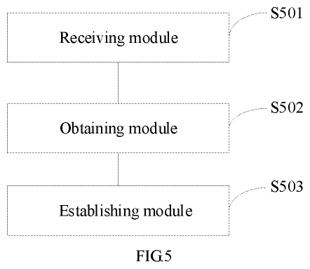

Exemplarily, the visitor information of any one or more visitors in the visitor group can be viewed, as shown in FIG. 3. The visitor information of a visitor in the visitor group can include an edit control. The edit operation for the visitor information can be a trigger operation such as clicking, touching, and sliding on the edit control. The terminal device can display the edit interface in response to the edit operation. The visitor information of the visitor can be edited manually in the edit interface, as shown in FIG. 4 (FIG. 4 shows three items of the visitor information as an example: a visitor name, contact information and a consumption possibility level. It should be noted that actually, more or less than three items in FIG. 4 can be shown).

In this way, through the interaction between the client and the server, information of the accompanying person(s) of the target visitor can be obtained based on the received follow-up request for the target visitor, and then the visitor group for the target visitor can be established according to the target visitor and the accompanying person(s) of the target visitor. According to the visitor information management method provided by the present disclosure, the visitor group can be established for visitors who visit together and visitors can be managed through the visitor group. In this way, customer information omissions and cases in which multiple salespersons are assigned to a same customer for follow-up can be effectively reduced. In addition, the data to determine the visitor group is the accompanying person data (e.g., including at least data of a group of accompanying persons to which the target visitor belongs) provided by the server-side. In this way, cases in which partial visitors are omitted due to manually determining the visitor group can be reduced, thereby improving the customer experience of the visitors, and implementing targeted management of the visitors.

In a possible implementation, the visitor group including the target visitor is established based on the target visitor and the accompanying persons of the target visitor includes: displaying the information of accompanying persons of the target visitor by the client; and in response to a first operation of selecting a target accompanying person, adding the target accompanying person to the visitor group, where the target accompanying person is a part or all of the accompanying persons of the target visitor.

For example, after obtaining the information of accompanying persons of the target visitor from the server-side, the information of accompanying persons of the target visitor can be displayed on the client. When displaying the information of accompanying persons of the target visitor at the terminal device, a display mode can be determined according to the number of accompanying persons. For example, up to 5 accompanying persons can be displayed in each row. If the number of accompanying persons to be displayed is less than or equal to 5, the multiple accompanying persons can be displayed in a same row. If the number of accompanying persons to be displayed is 6, the accompanying persons to be displayed can be displayed in two rows, and 3 accompanying persons can be displayed in each row. If the number of accompanying persons to be displayed is 7 or 8, the accompanying persons to be displayed can be displayed in two rows, 4 accompanying persons can be displayed in a first row, and 3 or 4 accompanying persons can be displayed in a second row. If the number of accompanying persons to be displayed is 9, the accompanying persons to be displayed can be displayed in two rows, 5 accompanying persons can be displayed in a first row, and 4 accompanying persons can be displayed in a second row. In an implementation of the embodiments of the present application, for optimal presentation to users such as salespersons, as the number of accompanying persons change, a display mode that adapts to the number of persons currently displayed can be selected.

The first operation may be used to select one or more target accompanying persons from the accompanying persons of the target visitor. An accompanying person corresponding to the first operation is the target accompanying person. The target accompanying person can be directly selected from the accompanying persons. In this way, the first operation can be a selection operation for the displayed information of accompanying persons, specifically the first operation can be a double-click, a long-press, etc. Alternatively, the target accompanying person can be selected from the accompanying persons by removing non-target accompanying persons. In this manner, the first operation can be a removing operation for the non-target accompanying persons. For example, if a selected accompanying person is a non-target accompanying person and is removed, remaining unselected accompanying persons are target accompanying persons. According to the first operation for the target accompanying persons, one or more accompanying persons can be selected from the accompanying persons of the target visitor to form a visitor group together with the target visitor.

In this way, since the accompanying persons of the target visitor are pre-determined by the server-side through the image recognition operation based on the captured images, with the first operation of selecting the target accompanying persons to establish the visitor group for the target visitor, accuracy of the established visitor group can be improved and it is more convenient for managing visitors.

In a possible implementation, the visitor group including the target visitor is established based on the target visitor and the accompanying persons of the target visitor includes: adjusting the visitor group for the target visitor according to visit data of the unfollowed-up visitors in the visitor list.

For example, the target accompanying person of the target visitor can be determined from the unfollowed-up visitors, and added to the visitor group for the target visitor based on the visit data of the unfollowed-up visitors in the visitor list.

In a possible implementation, adjusting the visitor group for the target visitor according to the visit data of the unfollowed-up visitors in the visitor list may include: displaying information of unfollowed-up visitors in the visitor list by the client; and in response to a second operation of selecting a target unfollowed-up visitor, adding the target unfollowed-up visitor to the visitor group.

For example, after establishing the visitor group for the target visitor, the information of unfollowed-up visitors in the visitor list can be displayed by the client. A visitor can be selected from the unfollowed-up visitors, to be added to the visitor group. Specifically, the target unfollowed-up visitor can be directly selected. In this way, the second operation can be a selection operation for the unfollowed-up visitors, and the unfollowed-up visitor corresponding to the selection operation can be the target unfollowed-up visitor. Alternatively, the target unfollowed-up visitor can be selected by removing the non-target unfollowed-up visitors. In this manner, the second operation can be a removing operation for the non-target unfollowed-up visitors and the remaining unselected are the target unfollowed-up visitors. The target unfollowed-up visitor can be added to the visitor group.

In a possible implementation, displaying the information of unfollowed-up visitors in the visitor list by the client may include: obtaining visit time of the unfollowed-up visitors in the visitor list from the server-side; and displaying the information of unfollowed-up visitors in the visitor list according to the visit time by the client. The unfollowed-up visitors in the visitor list are arranged according to the visit time, and/or according to similarity between the visit time of the unfollowed-up visitors and visit time of the target visitor.

For example, the visit time of the unfollowed-up visitors in the visitor list can be obtained from the server-side. For example, a visitor time request is sent to the server-side. The visitor time request includes identification information of the unfollowed-up visitors. After receiving the visitor time request, the server-side obtains the visit time of at least one unfollowed-up visitor, and feeds back the visit time of the at least one unfollowed-up visitor to the client. The at least one unfollowed-up visitor can be displayed according to the visit time of the at least one unfollowed-up visitor by the client. For example, the at least one unfollowed-up visitor can be arranged by how close they are from current time, or according to the similarity between the visit time of the at least one unfollowed-up visitor and the visit time of the target visitor, and an unfollowed-up visitor having similar visit time to the target visitor is ranked first. Where the smaller the time interval between the visit time of an unfollowed-up visitor and the visit time of the target visitor is, the higher the similarity between the visit time of the unfollowed-up visitor and the visit time of the target visitor will be.

In a possible implementation, after the visitor group including the target visitor is established based on the target visitor and the accompanying persons of the target visitor, the method may further include: determining a decision maker in the visitor group according to visit data of at least one visitor in the visitor group.

For example, the decision maker can be determined from the visitor group according to the visit data of the at least one visitor in the visitor group, and the decision maker has decision-making power in the visitor group, so that depending on the decision maker, a visit reminder of a consumer can be determined, dwell time can be calculated, and a type of a product of interest can be determined, etc. Alternatively, a decision maker can be manually determined from the visitor group, and the manner for determining the decision maker is not specifically limited in the present disclosure.

In a possible implementation, the decision maker may include at least one of the following: a visitor in the visitor group with visit frequency greater than a first threshold; a visitor in the visitor group with recorded visitor data volume greater than a second threshold; or a visitor in the visitor group with the number of visits greater than a third threshold. In the process of determining the visit frequency and/or the number of visits of the visitor, the visit frequency and/or the number of visits of the visitor within a preset time period may be determined based on the preset time period. The preset time period may be a preset period of time, and a range of the preset time period may be determined according to requirements.

The first threshold may be a lowest visit frequency of the decision maker, the second threshold may be a recorded minimum visitor data volume of the decision maker, and the third threshold may be a minimum number of visits of the decision maker. Values of the first threshold, the second threshold and the third threshold may be set based on requirements. The values of the first threshold, the second threshold and the third threshold may be the same or different, which are not specifically limited in the present disclosure. The visit frequency of the at least one visitor in the visitor group can be obtained from the server, and the visitor with the visit frequency greater than the first threshold can be determined to be the decision maker. When multiple decision makers are determined based on the first threshold, a visitor with the highest visit frequency among the multiple decision makers can be determined to be the decision maker. Alternatively, the visitor data volume of the at least one visitor can be obtained from the server-side, and a visitor with the visitor data volume greater than the second threshold is determined to be the decision maker. The visitor data volume may include: the number of visits, a visit time, a type of a product of interest, and personal information of visitors etc. Similarly, when multiple decision makers are determined based on the second threshold, a visitor with the greatest visitor data volume among the multiple decision makers can be determined to be the decision maker. Alternatively, the visit frequency of the at least one visitor in the visitor group can be obtained from the server-side, and a visitor with the number of visits greater than the third threshold can be determined to be the decision maker. When multiple decision makers are determined based on the third threshold, a visitor with the greatest number of visits among the multiple decision makers can be determined to be the decision maker. In addition, it is also possible to consider a combination of the visit frequency and/or the number of visits in the visitor group, as well as the recorded visitor data volume, and to select a visitor with the visit frequency greater than the first threshold and/or the number of visits greater than the third threshold, and with the recorded visitor data volume greater than the second threshold as the decision maker.

In a possible implementation, the accompanying persons of the target visitor are determined by the server-side according to trajectory information of multiple persons;

The trajectory information of at least one of the multiple persons is determined according to position information of a plurality of image capturing devices deployed in different regions, an image set corresponding to the at least one of the multiple persons, and time at which a person image is captured. A person detection result is obtained by performing, by the server-side, person detection on video images captured by the plurality of image capturing devices. The image set corresponding to the at least one of the multiple persons is determined based on the person detection result. The image set corresponding to the at least one of the multiple persons includes a person image of the at least one of the multiple persons.

For example, the plurality of image capturing devices can be deployed in different regions, and video images of each region can be captured by each of the plurality of image capturing devices. From the captured video images, video images captured by the plurality of image capturing devices within a preset time period can be obtained. The preset time period is one preset time length or multiple preset time lengths, and the range of each time length can be set according to requirements, which is not limited in the present disclosure. For example, when the preset time period includes a time length, the time length may be set to 5 minutes, and then multiple video images captured by the plurality of image capturing devices within 5 minutes can be obtained. For example, sampling is performed on a video stream captured by each image capturing device within 5 minutes. For example, a preset time interval (for example, 1 second) is used to analyze and extract frames from the video stream to obtain multiple video images.

It should be noted that, among the image capturing devices deployed in a number of different regions, regions that can be captured by each two image capturing devices may be partially or completely different. The regions that can be captured by two image capturing devices are partially different, and there is a partially overlapping region in the video images captured by the two image capturing devices at the same time.

For example, the person detection is used to detect a person in a video image. In the embodiments of the present application, it can be used to detect a video image with face information and/or human body information, and to obtain a person image with the face information, or with the human body information, or with both the face information and the human body information from the video image based on the face information and/or the human body information. Then, the image set corresponding to the at least one of the multiple persons is determined by using person images, where an image set corresponding to each person may include at least one person image.

For example, the position information of the image capturing device can be taken as second position information of the captured video image, which can be taken as the second position information of the corresponding person image, and capture time of the video image can be taken as time at which the corresponding person image is captured. For each person, the trajectory information of the person can be determined according to the second position information of the at least one person image in the image set corresponding to the person, first position information of the person in the at least one person image, and the time at which the person image is captured.

For example, for the image set corresponding to each person, spatiotemporal position coordinates of the person corresponding to the image set can be determined according to the second position information of the person image in the image set and the capture time. The spatiotemporal position coordinates refer to point coordinates in a three-dimensional spatiotemporal coordinate system. In the embodiments of the present application, each point in the three-dimensional spatiotemporal coordinate system can be used to reflect a geographic position of a person and the time at which a video image of the person is captured. For example, the geographic position of the person, that is, position information of the person, can be identified by an x-axis and a y-axis, and the time at which the video image of the person is captured can be represented by a z-axis. Taking a single person as an example, the trajectory information of the person can be established according to the spatiotemporal position coordinates corresponding to multiple person images included in the image set of the single person. Considering that the multiple person images are obtained from a video sequence by sampling, the trajectory information of the single person can be expressed as a point group composed of spatiotemporal position coordinates, and each point in the point group is a discrete point in the spatiotemporal coordinate system.

For example, after determining the trajectory information of the at least one of the multiple persons, the accompanying persons among the multiple persons may be determined according to the trajectory information. For example, at least two persons with similar trajectory information may be determined to be the accompanying persons. Alternatively, the trajectory information of the at least one person may be clustered, and each group of persons obtained after the clustering is determined to correspond to a group of accompanying persons.

For example, customer A and customer B come into a 4S shop at 3 pm and stay at reception for 15 minutes, then leave for an XXF6 model car at the same time. Customer A goes to an XXF7 model car after staying 10 minutes at the XXF6 model car, while customer B goes to the XXF7 model car after staying 13 minutes at the XXF6 model car. They leave the 4S shop at 4 o'clock together.

After the person detection is performed on video images captured by image capturing devices deployed respectively in a region where the reception is located, a region where the XXF6 model car is located, and a region where the XXF7 model car is located, multiple person images of customer A and customer B are obtained respectively. An image set 1 including person images of customer A and an image set 2 including person images of customer B can be obtained respectively based on the multiple person images. Take the image set 1 including the person images of customer A as an example, trajectory information 1 of customer A may be obtained based on the capture time of a video image corresponding to at least one person image in the image set 1, the position of an image capturing device for capturing the video image (that is, the second position information), and the first position information of customer A in the at least one person image. Similarly, trajectory information 2 of customer B may be obtained based on the image set 2 including person images of customer B. Since the customer A and the customer B arrive at the region where the reception is located at the same time, then appear in the same two regions, and stay in the same two regions for the same or similar time period/leave at the same or similar time, finally leave the last visited region at the same time. Therefore, the customer A and the customer B can be determined to be accompanying persons based on the trajectory information 1 and the trajectory information 2.

The trajectory information of at least one person can be established based on the position information and the capture time of images corresponding to the at least one person captured within a preset time period by the plurality of image capturing devices deployed in different regions, and the accompanying persons are determined from multiple persons based on the trajectory information of the at least one person. Because trajectory information can better reflect dynamics of at least one person, therefore, determining the accompanying persons based on the trajectory information can improve accuracy of detection for accompanying persons.

In a possible implementation, performing person detection on the person images to determine the image set corresponding to the at least one of the multiple persons according to the obtained person detection result may include: performing person detection on the video images to obtain person images including detection information. The person detection includes face detection and/or human body detection. When the person detection includes the face detection, the detection information includes face information. When the person detection includes the human body detection, the detection information includes human body information. The image set corresponding to at least one of the multiple persons is determined based on the person images.

For example, the face detection may be performed on the video images, and after face information is detected, a framed region including the face information in a video image is extracted in a form of a rectangular frame etc., as a person image, that is, the video image includes the face information; and/or, the human body detection can be performed on the video image, and after the human body information is detected, an region including the human body information in the video image is extracted in a form of a rectangular frame etc., as a person image. The human body information may include face information, the person image obtained by extracting the region of the human body information may include the human body information, or both the face information and the human body information.

It should be noted that the process of obtaining the person image may include but is not limited to the above-exemplified situations. For example, in the process of extracting a person image from a video image, other forms may also be used for extraction of a region including the face information and/or the human body information.

By using the face information and/or human body information included in the person images, the person images can be divided into sets according to the persons in the person images and the image set of the at least one of the multiple persons can be obtained. That is, the person images corresponding to each person are regarded as an image set. In this way, after the person images including the face information and/or human body information are obtained, an image set corresponding to each person can be established based on the person images. For the image set corresponding to each person, the trajectory information of the person can be determined, that is, the trajectory information of the person can be fitted based on the person images in the image set and the trajectory information of each of the multiple images can be respectively fitted based on the image set corresponding to each of the multiple persons.

In a possible implementation, determining the trajectory information of the at least one person according to the position information of the plurality of image capturing devices, the image set corresponding to the at least one person, and the time at which the person image is captured may include: for at least one person image in the image set corresponding to the at least one of the multiple persons, determining the first position information of a target person in the at least one person image in video images corresponding to the at least one person image; determining a spatial position coordinate of the target person in a spatial coordinate system based on the first position information and the second position information, where the second position information is position information of the image capturing devices for capturing the video images corresponding to the at least one person image; obtaining a spatiotemporal position coordinate of the target person in the spatiotemporal coordinate system according to the spatial position coordinate and time at which the video images corresponding to the at least one person image are captured; and obtaining the trajectory information of the at least one of the multiple persons in the spatiotemporal coordinate system based on the spatiotemporal position coordinates of the multiple persons.

For example, for at least one person image in each image set, the first position information of the person corresponding to the image set in the person image can be identified, and then the spatial position coordinate of the person in the spatial coordinate system is determined according to the first position information of the person in the person image and the second position information of the image capturing device that captures the video image corresponding to the person image. A point in the spatial coordinate system can be used to represent the geographic position information where the person is actually located, for example, it can be represented by (x, y). Combined with the capture time t of the video image corresponding to the person image, a point used to represent the person in the spatiotemporal coordinate system can be obtained, for example, it can be represented by the spatiotemporal position coordinate (x, y, t). Similarly, for a same image set, the spatiotemporal position coordinates of the at least one person image in the image set can be obtained to form the trajectory information of the person corresponding to the same image set. The trajectory information can be expressed as a point group composed of multiple spatiotemporal position coordinates. In the embodiments of the present application, since the person image is obtained from a sampled video image, the point group can be a collection of discrete points. Using a similar implementation, the point group corresponding to each image set can be obtained, that is, the trajectory information of the person corresponding to each image set can be obtained.

Since the trajectory information of each person can reflect a relationship between the position of the person and the time, in the embodiments of this application, accompanying persons usually refer to two or more persons with similar or same movement trends. At least one group of accompanying persons can be more accurately determined from multiple persons by using the trajectory information, thereby improving the accuracy of detection for the accompanying persons.

In a possible implementation, determining the accompanying persons of the target visitor according to the trajectory information of the multiple persons may include: clustering the trajectory information of the multiple persons to obtain a cluster set including the trajectory information of the target visitor; and determining persons corresponding to multiple groups of trajectory information in the cluster set as a group of accompanying persons.

For example, the obtained trajectory information of the multiple persons may be clustered to obtain a clustering result, where the clustering result refers to dividing the trajectory information of multiple persons into at least one cluster set by means of clustering to obtain a cluster set including the trajectory information of the target visitor. Each cluster set includes at least the trajectory information of one person. In an implementation of the embodiments of the present application, persons corresponding to the trajectory information belonging to the same cluster set may be determined to be a group of accompanying persons. The manner for clustering trajectory information is not limited in the present disclosure.

In this way, because the trajectory information may indicate the relationship between each position of the person and time during the movement, a group of persons with a more similar movement process can be obtained by clustering multiple persons using the trajectory information. The group of persons is a group of accompanying persons defined in the embodiments of the present application, thus improving the accuracy of detection for accompanying persons.

In a possible implementation, the trajectory information of the at least one of the multiple persons includes point groups in the spatiotemporal coordinate system; determining the accompanying persons of the target visitor according to the trajectory information of the multiple persons may include: for each two persons of the multiple persons, determining a similarity for point groups corresponding to the two persons in the spatiotemporal coordinate system in the trajectory information of the multiple persons; determining multiple person pairs based on a comparison between the similarity and a first similarity threshold, where each of the multiple person pairs includes two persons, and the value of the similarity of each of the multiple person pairs is greater than the first similarity threshold; and determining the accompanying persons of the target visitor based on the multiple person pairs.

For example, the similarity of the point groups corresponding to each two persons in the spatiotemporal coordinate system can be determined based on the spatiotemporal position coordinates of the point groups corresponding to the two persons in the spatiotemporal coordinate system. When the similarity of the point groups corresponding to the two persons in the spatiotemporal coordinate system is greater than or equal to the first similarity threshold, the two persons may be determined to be a person pair. The similarity threshold is a preset value for determining whether two persons are accompanying persons. The first similarity threshold may be a preset value for determining whether two persons are accompanying persons for a first time. A second similarity threshold in the following implementations may be a preset value for determining whether two persons are accompanying persons for a second time. The second similarity threshold is greater than the first similarity threshold. The values of the first similarity threshold and the second similarity threshold can be determined according to requirements. The values of the first similarity threshold and the second similarity threshold are not limited herein in the present disclosure. For each two persons among multiple persons, the above method can be used to determine whether a person pair can be formed, multiple person pairs can be determined from the multiple persons, and at least one group of accompanying persons is determined from the multiple person pairs according to an overlap of the persons included in the multiple person pairs, where the at least one group of accompanying persons includes a group of accompanying persons corresponding to the target visitor.

For example, multiple persons A, B, C, D, E, and F form multiple person pairs, and the multiple person pairs are AB, AC, CD, EF respectively. Because there are overlapped persons between at least two person pairs among AB, AC, and CD, for example, there is A in both AB and AC, persons A, B, C, and D form a group of accompanying persons, and persons E and F form a group of accompanying persons.

In this way, by determining the similarity of the point groups for two persons in the spatial coordinate system, it can be determined whether the two persons can form accompanying persons, that is, a person pair, and multiple person pairs can be determined from multiple persons in this way. Further, it is possible to determine at least one group of accompanying persons from the multiple person pairs according to whether there is an overlap between the multiple person pairs, that is, whether there is a same person.

In a possible implementation, for each two persons of the multiple persons, determining the similarity for the point groups corresponding to the two persons in the spatiotemporal coordinate system in the trajectory information of the multiple persons may include: for a first person and a second person in the two persons, determining a spatial distance between at least one first spatiotemporal position coordinate corresponding to the first person in the spatiotemporal coordinate system and at least one second spatiotemporal position coordinate corresponding to the second person in the spatiotemporal coordinate system; determining a first number of first spatiotemporal position coordinates corresponding to the spatial distance less than or equal to a distance threshold, and a second number of second spatiotemporal position coordinates corresponding to the spatial distance less than or equal to the distance threshold; determining a first ratio of the first number to a total number of the at least one first spatiotemporal position coordinate, and a second ratio of the second number to a total number of the at least one second spatiotemporal position coordinate; and determining a maximum value of the first ratio and the second ratio as the similarity of the two persons.

For example, two persons, e.g., the first person and the second person, can be determined from multiple persons randomly or according to a certain rule. At least one spatiotemporal position coordinate in the point group corresponding to the first person in the spatiotemporal coordinate system is determined to be the first spatiotemporal position coordinate, and at least one spatiotemporal position coordinate in the point group corresponding to the second person in the spatiotemporal coordinate system is determined to be the second spatiotemporal position coordinate. Spatial distances between each first spatiotemporal position coordinate and each second spatiotemporal position coordinate are determined. That is, for each first spatiotemporal position, the spatial distances between the first spatiotemporal position and each second spatiotemporal position coordinate are calculated. In this way, the spatial distances between each first spatiotemporal position coordinate and each second spatiotemporal position coordinate are obtained. Assuming that the point group for the first person in the spatiotemporal coordinate system has a first spatiotemporal position coordinates, and the point group for the second person in the spatiotemporal coordinate system has b second spatiotemporal position coordinates, a×b spatiotemporal distances can be determined in total. The manner for calculating the spatial distance is not specifically limited in the present disclosure.

Each first spatiotemporal position coordinate of the first person corresponds to b spatiotemporal distances. Taking a first spatiotemporal position coordinate as an example, if there is a spatiotemporal distance determined based on the first spatiotemporal position coordinate less than or equal to the distance threshold (the distance threshold may be a preset value, which can be selected as required. The value of the distance threshold is not limited in the present disclosure), it can be determined that the spatiotemporal distance corresponding to the first spatiotemporal position coordinate is less than or equal to the distance threshold. In the above manner, the first number c of the first spatiotemporal position coordinates, the spatiotemporal distances of which are less than or equal to the distance threshold among the spatiotemporal distances corresponding to a first spatiotemporal position coordinates of the first person, is determined, where c is less than or equal to the total number of the first spatiotemporal position coordinates of the first person. In the same way, the second number d of the second spatiotemporal position coordinates, the spatiotemporal distances of which are less than or equal to the distance threshold (preset value) among the spatiotemporal distances corresponding to b second spatiotemporal position coordinates of the second person, is determined, where d is less than or equal to the total number of the second spatiotemporal position coordinates of the second person. Based on the above, it can be determined that the first ratio corresponding to the first person is c/a, the second ratio corresponding to the second person is d/b. And then a maximum value between the first ratio and the second ratio is determined to be the similarity between the first person and the second person. That is, it can be determined that c/a is the similarity between the first person and the second person when c/a is greater than d/b, and that d/b is the similarity between the first person and the second person when c/a is less than d/b. It should be noted that when the first ratio and the second ratio are the same, the first ratio and/or the second ratio may be determined to be the similarity between the first person and the second person.

In this way, for each two persons among the multiple persons, the above method can be used to determine the similarity, so as to obtain the similarity of the trajectory information of each two persons.

In a possible implementation, determining the accompanying persons of the target visitor based on the multiple person pairs includes: establishing an accompanying person set based on a first person pair in the multiple person pairs, where the first person pair includes the target visitor; determining an associated person pair from at least one second person pair of the multiple person pairs other than a person pair included in the accompanying person set, where the associated person pair includes at least one person in the accompanying person set adding the associated person pair into the accompanying persons set; and determining persons other than the target visitor in the accompanying person set as the accompanying persons of the target visitor.

For example, a person pair including the target visitor in the multiple person pairs is determined to be the first person pair, and two persons included in the first person pair are taken as two persons in an accompanying person set to establish the accompanying person set. Alternatively, the accompanying person set may be established according to a certain rule, for example, by selecting a person pair with relatively higher similarity among multiple person pairs as the first person pair. Afterwards, the person pair in which at least one of the two persons does not belong to the accompanying person set is determined to be the second person pair, where the second person pair may include or exclude the person in the accompanying person set. For each second person pair, if the second person pair includes any person in the accompanying person set, the second person pair is taken as an associated person pair and added into the accompanying person set. In this way, determination of the accompanying persons of the target visitor can be achieved based on the first person pair.

For example, still taking the above example as an example, an accompanying person set is established by taking the person pair AB among the multiple person pairs AB, AC, CD, EF as the first person pair, where the accompanying person set includes the person A and the person B. Remaining multiple person pairs are determined to be the second person pairs (e.g., AC, CD, and EF), where the person pair AC in the second person pairs includes the person A, then the person pair AC is added to the accompanying person set as an associated person pair. In this case, the accompanying person set includes the person A, the person B and the person C. It is determined that the person pair CD in the remaining second person pairs includes the person C, and then the person pair CD is added to the accompanying persons set as an associated person pair. In this case, the accompanying person set includes the person A, the person B, the person C, and the person D. So far, the remaining second person pair EF does not include any person in the accompanying persons set. Thus, the person A, the person B, the person C, and the person D in the accompanying person set are determined to be a group of accompanying persons. That is, at least one group of accompanying persons can be obtained from the multiple person pairs based on the overlapping/repeating relationship of the persons included in the multiple person pairs.

In a scenario of store marketing, there may be situations where a same staff member accompanies multiple groups of persons, so there may be a great number of persons who form a person pair with the staff member respectively. In a specific scenario, there may be suspicious persons such as thieves, then the suspicious persons such as the thieves will also be grouped into multiple persons pairs. The staff member may refer to a person who provides services to various persons in the store marketing scene, such as a salesperson. Considering a purpose of accompanying persons grouping, it can be aimed at determining targeted marketing plans that are suitable for the accompanying persons. Therefore, a person who does not have an intention to buy, such as a salesperson, is usually not considered. In order to solve the case that there is a person in a group of accompanying persons who does not belong to the accompanying persons due to above-mentioned misidentification, in a possible implementation, adding the associated person pair into the accompanying person set may include: determining the number of person pairs including a first person in the associated person pair; and in response to determining that the number of person pairs including the first person is less than a person pair number threshold, adding the associated person pair into the accompanying person set.

For example, any person in the associated person pair can be determined to be the first person, and the number of the person pairs including the first person can be determined, for example, person A in the associated person pair AC forms person pairs AB and AC with person B and person C respectively, thus the number of the person pairs including person A is 2. When the number of person pairs including any person in the associated person pair is less than the person pair number threshold (which is a preset value, and the person pair number threshold can be selected as needed, the value of the person pair number threshold is not limited in the present disclosure), it can be determined that the associated person pair can be added to the accompanying person set to form a group of accompanying persons with the persons in the accompanying person set. When the number of person pairs including a person in the associated person pair is greater than or equal to the person pair number threshold, the person can be determined to be a staff member, and the associated person pair is not added to the accompanying persons set, so as to reduce the occurrence of merging accompanying persons of one group with the accompanying persons of other groups due to the staff member.

Considering that with the technical solutions provided by the embodiments of the present application, it is likely to obtain a group of accompanying persons including a larger number of persons. In order to improve the accuracy of determining a group of accompanying persons, the persons included in the group of accompanying persons are filtered when the number of persons included in the group of accompanying persons is large, to delete one or more persons who are unlikely to be accompanying persons from the group of accompanying persons. In a possible implementation, after determining the at least one group of accompanying persons according to the multiple person pairs, the method may further include: in response to determining that the number of persons in the group of accompanying person is greater than a first number threshold, determining at least one of the multiple person pairs with the similarity greater than a second similarity threshold to be a group of accompanying persons. In this way, the number of persons in the group of accompanying persons is less than the first number threshold, where the second similarity threshold is greater than the first similarity threshold.

For example, the first number threshold is a preset maximum number of persons in a group of accompanying persons, and the value of the first number threshold can be selected according to requirements, which is not limited in the present disclosure. When the number of persons in the group of accompanying persons is greater than the first number threshold, at least one of the multiple person pairs among the accompanying persons with the similarity greater than the second similarity threshold may be determined to be a group of accompanying persons. In turn, the number of the accompanying persons meets the requirements while improving the accuracy of the accompanying person detection. The second similarity threshold is a preset value greater than the first similarity threshold, and can be selected according to requirements, which is not limited in the present disclosure. It can be seen that based on the obtained group of accompanying persons, a secondary filtering can be performed to remove person pairs with the similarity less than or equal to the second similarity threshold, thereby reducing the number of persons in the group of accompanying persons.

In a possible implementation, determining the image set corresponding to the at least one of the multiple persons based on the person images includes: performing clustering process on the person images including the face information to obtain a face clustering result, where the face clustering result includes at least one face identity of the person images including the face information; performing clustering process on the person images including the human body information to obtain a human body clustering result, where the human body clustering result includes at least one human body identity of the person images including the human body information; and determining the image set corresponding to the at least one of the multiple persons according to the face clustering result and the human body clustering result.

For example, a person image including the face information may be determined from person images, and a person image including the human body information may be determined from the person images. Person images including the face information may be clustered. For example, face features in at least one person image may be extracted, and a face clustering result is obtained by performing a face clustering on the extracted face features. Exemplarily, a face clustering process is performed on the person images including the face information by using a trained model, for example, a pre-trained neural network model for face clustering. The person images including the face information are clustered into multiple categories, and a face identity is assigned to each category. In this way, each person image including the face information has a face identity, and the person images including the face information that belong to a same category have a same face identity, while person images including the face information that belong to different categories have different face identities, thus the face clustering result is obtained. The manner of face clustering is not limited in the present disclosure.

Similarly, the person images including the human body information may be clustered. For example, human body features in at least one person image may be extracted, and a human body clustering result is obtained by performing a clustering on the extracted human body features. Exemplarily, a human body clustering process may be performed on the person images including the human body information by using a trained model, for example, a pre-trained neural network model for human body clustering, the person images including the human body information are clustered into multiple categories, and a human body identity is assigned to each category. In this way, each person image including the human body information has a human body identity, and the person images including the human body information belonging to a same category have a same human body identity, while person images including the human body information that belong to different categories have different human body identities, thus the human body clustering result is obtained. The manner of human body clustering is not limited in the present disclosure.

For person images with both face information and human body information, the face identity is obtained by performing face clustering and the human body identity is obtained by performing human body clustering. The face identity can be associated with the human body identity through the person images that have both the face information and the human body information. An image set of a person can be obtained by performing a determination on person images of the same person (person images including the face information and person images including the human body information) based on the associated face identity and human body identity.

In a possible implementation, before performing clustering process on the person images including the human body information, the person images may be filtered according to completeness of the human body information included in the person images, and the clustering process is performed on the filtered person images to obtain the human body clustering result. In this way, persons images without sufficient precision and reference significance are excluded, thus improving clustering accuracy. For example, key point information of the human body can be preset. The key point information of the human body in the person images can be detected. The completeness of the human body information in the person images can be determined according to a degree of matching between the detected key point information of the human body and a preset key point information of the human body. A person image with incomplete human body information is deleted to remove the person image. Exemplarily, a pre-trained neural network for detecting the completeness of human body information may be used to filter the person image, which is not repeated in this disclosure.

In a possible implementation, determining the image set corresponding to the at least one of the multiple persons based on the face clustering result and the human body clustering result may include: determining at least one correspondence between the face identities and the human body identities in person images including the face information and the human body information; and obtaining, from the person images including the face information and the human body information, person images including face information and/or human body information in a first correspondence among the at least one correspondence based on the first correspondence, to form an image set corresponding to a person.

The first correspondence may be selected randomly from all the correspondences or selected according to a certain rule. For example, a person image including both the face information and the human body information can be determined, the face clustering is performed on the person image to obtain the face identity and the human body clustering is performed on the person image to obtain the human body identity. In this case, the person image has both the face identity and the human body identity.

The human body identity and the face identity corresponding to the same person can be associated through the person images including face information and human body information, and three categories of the person images corresponding to the same person may be obtained. The first category is a person image that includes only the human body information, the second category is a person image that includes only the face information, and the third category is a person image that includes both the human body information and the face information. An image set corresponding to the person is formed by the three categories of person images. Trajectory information of the person is established according to the geographic position information where the person in the image set is actually located and the capture time.

For each correspondence, the above method can be used to determine the image set corresponding to the person corresponding to the correspondence. In this way, the face clustering results and the human body clustering results complement each other. This can enrich the person images in the image set corresponding to the person, and then more abundant trajectory information can be determined through the enriched person images.

Since the accuracy of the human body clustering is lower than that of the face clustering, multiple person images corresponding to the same human body identity may correspond to multiple face identities. For example, there are 20 person images with both face information and human body information corresponding to the human body identity BID1, but the 20 person images correspond to 3 face identities: FID1, FID2, and FID3. The face identity of the same person corresponding to the human body identity BID1 needs to be determined from the 3 face identities.

In a possible implementation, determining the at least one correspondence between the face identities and the human body identities in the person images including the face information and the human body information includes: obtaining the face identities and the human body identities of the person images including the face information and the human body information; obtaining at least one human body image group by grouping the person images including the face information and the human body information according to the human body identities of the person images, where the person images in the same human body image group have the same human body identity; and for a first human body image group in human body image groups, the face identities corresponding to at least one person image in the first human body image group are determined, and the correspondences between the face identities and the human body identities of the person images in the first human body image group are determined according to the number of the person images corresponding to at least one face identity in the first human body image group.

For example, person images including the face information and the human body information can be determined, and the face identities and the human body identities of the person images can be obtained. The person images are grouped according to the human body identities of the person images. For example, there are 50 person images including the face information and the human body information. There are 10 person images corresponding to the human body identity BID1, which can form a human body image group 1. There are 30 person images corresponding to the human body identity BID2, which can form a human body image group 2. There are 10 person images corresponding to the human body identity BID3, which can form a human body image group 3.

The first human body image group may be one selected randomly among all human body image groups, or may be selected according to a certain rule. For the first human body image group, the face identities corresponding to at least one person image in the first human body image group can be determined, and the number of person images corresponding to the same face identity can be determined. The correspondences between the face identities and the human body identities of the person images in the first human body image group are determined according to the number of the person images corresponding to at least one face identity in the first human body image group.

For example, it can be determined that the face identity corresponding to the largest number of person images in the first human body image group corresponds to the human body identity. Alternatively, it can be determined that the face identity corresponding to the number of person images in the first human body image group with a proportion greater than a threshold in the first human body image group corresponds to the human body identity.

Taking the human body image group 2 as an example, it is determined that among the 30 person images in the human body image group 2, there are 20 person images with the identity FID1, 4 person images with the identity FID2, and 6 person images with the identity FID3. It can be determined that the face identity associated with the human body identity BID2 is FID1. Alternatively, if the threshold is set to be 50%, the proportion of FID1 is 67%, the proportion of FID2 is 13%, and the proportion of FID3 is 20%. It can be determined that the face identity associated with the human body identity BID2 is FID1.

For each human body image group, the above method can be used to determine each correspondence between the face identities and the human body identities of the person images including the face information and the human body information. In this way, the accuracy of the clustering can be improved through mutual correction of the face clustering results and the human body clustering results, and the accuracy of the image set corresponding to the person obtained according to the human body clustering results and the face clustering results can be improved. Thus, more accurate trajectory information can be determined based on more accurate image set.

In a possible implementation, the determining the at least one correspondence between the face identities and the human body identities in the person images including the face information and the human body information includes: obtaining the face identities and the human body identities of the person images including the face information and the human body information; obtaining at least one face image group by grouping the second images including the face information and the human body information according to the face identities to which they belong, where the person images in the same face image group have the same face identity; and for a first face image group in the face image group, determining the human body identity corresponding to at least one person image in the first face image group, and determining the correspondences between the face identities and the human body identities of the person images in the first face image group according to the number of person images corresponding to the at least one human body identity in the first face image group.

For example, person images including the face information and the human body information can be determined, and the face identities and human body identities of the person images can be obtained. The person images are grouped according to the face identities to which the person images belong. For example, there are 50 person images including the face information and the human body information. Among the 50 person images, there are 10 person images corresponding to the face identity FID1, and the 10 person images can form the face image group 1. There are 30 person images corresponding to the face identity FID2, and the 30 person images can form the face image group 2. There are 10 person images corresponding to the face identity FID3, and the 10 person images can form the face image group 3.

The first face image group may be one selected randomly among all face image groups, or may be selected according to a certain rule. For the first face image group, the human body identity corresponding to at least one person image in the first face image group can be determined, and the number of person images corresponding to the same human body identity can be determined. The correspondences between the face identities and the human body identities of the person images in the first face image group are determined according to the number of the person images corresponding to the at least one human body identity in the first face image group.

For example, it may be determined that the human body identity corresponding to the largest number of person images in the first face image group corresponds to the face identity. Alternatively, it may be determined that he human body identity corresponding to the number of person images in the first face image group with a proportion greater than a threshold in the first face image group corresponds to the face identity.

Taking the face image group 2 as an example, it is determined that among the 30 person images in the face image group 2, there are 20 person images with the human body identity BID1, 4 person images with the human body identity BID2, and 6 person images with the human body identity BID3. It can be determined that the human body identity associated with the face identity FID2 is BID1. Alternatively, if the threshold is set to be 50%, the proportion of BID1 is 67%, the proportion of BID2 is 13%, and the proportion of BID3 is 20%. It can be determined that the human body identity associated with the face identity FID2 is BID1.

For each face image group, the above method can be used to determine each correspondence between the face identities and the human body identities of the person images including the face information and the human body information. In this way, the accuracy of the clustering can be improved through mutual correction of the face clustering results and the human body clustering results, and the accuracy of the image set corresponding to the person obtained according to the human body clustering results and the face clustering results can be improved. Thus, more accurate trajectory information can be determined based on more accurate image set.

In a possible implementation, determining the image set corresponding to the at least one of the multiple persons according to the face clustering result and the human body clustering result may include: for person images that include the face information in the image set, determining image sets corresponding to the at least one person according to the face identities of the person images.

For example, for person images that does not belong to any image set and includes face features in the person images, at least one image set can be established for this type of person images according to the face identities to which they belong. The second images in any established image set have the same face identity.

In this way, multiple image sets can be obtained, thereby achieving clustering of all person images. Furthermore, the trajectory information of the corresponding person can be established according to the second position information of the person images in the at least one image set and the capture time. Thus, at least one group of accompanying persons can be determined from multiple persons according to the trajectory information of the at least one person.

It can be understood that the above method embodiments mentioned in the present disclosure can be combined with each other to form a combined embodiment without violating the principle and logic, and will not be repeated herein again. It will be understood by those skilled in the art that, in the described method of the detailed description, the specific order of implementation of each step should be determined by its function and possibly intrinsic logic.

In addition, the present disclosure further provides an apparatus for managing visitor information, an electronic device, a computer readable storage medium, and programs, all of which can be used for implementing any method for managing visitor information provided by the present disclosure. Reference can be made to corresponding disclosure in the method portions for corresponding technical solutions and descriptions, and details thereof are not described herein again.

FIG. 5 illustrates a block diagram of an apparatus for managing visitor information according to one or more embodiments of the present disclosure. As shown in FIG. 5, the apparatus for managing visitor information includes:

a receiving module 501, configured to receive follow-up request for a target visitor, wherein the target visitor is included in unfollowed-up visitors in a visitor list; an obtaining module 502, configured to obtain information of accompanying persons of the target visitor from a server-side in response to the follow-up request received by the receiving module; and an establishing module 503, configured to establish a visitor group including the target visitor based on the target visitor and the information of accompanying persons of the target visitor obtained by the obtaining module, to associate information of multiple visitors in the visitor group, and to display the information of multiple visitors in the visitor group by a client.

In this way, through the interaction between the client and the server, information of the accompanying person(s) of the target visitor can be obtained based on the received follow-up request for the target visitor, and then the visitor group for the target visitor can be established according to the target visitor and the accompanying person(s) of the target visitor. According to the visitor information management method provided by the present disclosure, the visitor group can be established for visitors who visit together and visitors can be managed through the visitor group. In this way, customer information omissions and cases in which multiple salespersons are assigned to a same customer for follow-up can be effectively reduced. In addition, the data to determine the visitor group is the accompanying person data (e.g., including at least data of a group of accompanying persons to which the target visitor belongs) provided by the server-side. In this way, cases in which partial visitors are omitted due to manually determining the visitor group can be reduced, thereby improving the customer experience of the visitors and implementing targeted management of the visitors.

In a possible implementation, the establishing module 503 may be further configured to: display the information of accompanying persons of the target visitor by the client; and in response to a first operation of selecting a target accompanying person, add the target accompanying person to the visitor group, wherein the target accompanying person is a part or all of the accompanying persons of the target visitor.

In a possible implementation, the establishing module 503 may be further configured to: adjust the visitor group for the target visitor according to visit data of the unfollowed-up visitors in the visitor list.

In a possible implementation, the establishing module 503 may be further configured to: display information of the unfollowed-up visitors in the visitor list by the client; and in response to a second operation of selecting a target unfollowed-up visitor, add the target unfollowed-up visitor to the visitor group.

In a possible implementation, the establishing module 503 may be further configured to: obtain visit time of the unfollowed-up visitors in the visitor list from the server-side; and display the information of unfollowed-up visitors in the visitor list according to the visit time by the client; where the unfollowed-up visitors in the visitor list are arranged according to the visit time, and/or according to similarity between the visit time of the unfollowed-up visitors and visit time of the target visitor.

In a possible implementation, the apparatus may further include: a first determining module configured to determine a decision maker in the visitor group according to visit data of at least one visitor in the visitor group.

In a possible implementation, the decision maker includes at least one of: a visitor in the visitor group with visit frequency greater than a first threshold; a visitor in the visitor group with recorded visitor data volume greater than a second threshold; or a visitor in the visitor group with the number of visits greater than a third threshold.

In a possible implementation, the accompanying persons of the target visitor are determined by the server-side according to trajectory information of multiple persons;

Where trajectory information of at least one of the multiple persons is determined according to position information of a plurality of image capturing devices deployed in different regions, an image set corresponding to the at least one of the multiple persons, and time at which a person image is captured, wherein a person detection result is obtained by performing, by the server-side, person detection on video images captured by the plurality of image capturing devices, the image set corresponding to the at least one of the multiple persons are determined based on the person detection result, and the image set corresponding to the at least one of the multiple persons includes a person image of the at least one of the multiple persons.

In a possible implementation, the apparatus may include a second determining module, configured to: for at least one person image in the image set corresponding to the at least one of the multiple persons, determine first position information of a target person in the at least one person image in video images corresponding to the at least one person image; determine a spatial position coordinate of the target person in a spatial coordinate system based on the first position information and second position information, wherein the second position information is position information of the image capturing devices for capturing the video images corresponding to the at least one person image; obtain a spatiotemporal position coordinate of the target person in the spatiotemporal coordinate system according to the spatial position coordinate and time when the video images corresponding to the at least one person image are captured; and obtain the trajectory information of the at least one of the multiple persons in the spatiotemporal coordinate system based on spatiotemporal position coordinates of the multiple persons.

In a possible implementation, the apparatus includes a third determining module, configured to: cluster the trajectory information of the multiple persons to obtain a cluster set including the trajectory information of the target visitor; and determine persons corresponding to multiple groups of trajectory information in the cluster set as a group of accompanying persons.

In a possible implementation, the trajectory information of the at least one of the multiple persons includes point groups in the spatiotemporal coordinate system; the second determining module is further configured to: for each two persons of the multiple persons, determine a similarity for point groups corresponding to the two persons in the spatiotemporal coordinate system in the trajectory information of the multiple persons; determine multiple person pairs based on a comparison between the similarity and a first similarity threshold, wherein each of the multiple person pairs includes two persons, and a value of the similarity of each of the multiple person pairs is greater than the first similarity threshold; and determine the accompanying persons of the target visitor based on the multiple person pairs.

In a possible implementation, the second determining module is further configured to: establish an accompanying person set based on a first person pair in the multiple person pairs, wherein the first person pair includes the target visitor; determine an associated person pair from at least one second person pair of the multiple person pairs other than a person pair included in the accompanying person set, wherein the associated person pair includes at least one person in the accompanying person set; add the associated person pair into the accompanying persons set; and determine persons other than the target visitor in the accompanying person set as the accompanying persons of the target visitor.

In a possible implementation, the second determining module is further configured to: determine the number of person pairs including a first person in the associated person pair; and in response to determining that the number of person pairs including the first person is less than a person pair number threshold, add the associated person pair into the accompanying person set.

In a possible implementation, the apparatus further includes a fourth determining module, configured to: in response to determining that the number of persons in the accompanying persons of the target visitor is greater than a first number threshold, determine at least one of the multiple person pairs with the similarity greater than a second similarity threshold to be a group of accompanying persons, such that the number of persons in the group of accompanying persons is less than the first number threshold, wherein the second similarity threshold is greater than the first similarity threshold.

In a possible implementation, the second determining module is further configured to: for a first person and a second person in the two persons, determine a spatial distance between at least one first spatiotemporal position coordinate corresponding to the first person in the spatiotemporal coordinate system and at least one second spatiotemporal position coordinate corresponding to the second person in the spatiotemporal coordinate system; determine a first number of first spatiotemporal position coordinates corresponding to the spatial distance less than or equal to a distance threshold, and a second number of second spatiotemporal position coordinates corresponding to the spatial distance less than or equal to the distance threshold; determine a first ratio of the first number to a total number of the at least one first spatiotemporal position coordinate, and a second ratio of the second number to a total number of the at least one second spatiotemporal position coordinate; and determine a maximum value of the first ratio and the second ratio as the similarity of the two persons.

In some embodiments, functions or the included modules of the apparatus provided in the embodiments of the present disclosure may be used to perform the method described in the above method embodiments. For specific implementation, reference may be made to the description of the above method embodiments. For brevity, details are not described herein again.

An embodiment of the present disclosure further provides a computer readable storage medium having computer program instructions stored thereon, wherein when the computer program instructions are executed by a processor, the above methods are implemented. The computer-readable storage medium may be a non-volatile computer-readable storage medium.

An embodiment of the present disclosure further provides an electronic device, including: a processor, and a memory for storing processor-executable instructions, wherein the processor is configured to invoke the instructions stored in the memory to perform the above methods.

An embodiment of the present disclosure further provides a computer program product, including computer readable codes, wherein when the computer readable codes are run in an electronic device, a method for managing visitor information in any of the above embodiments is performed by a processor in the electronic device.

An embodiment of the present disclosure further provides another computer program product for storing computer-readable instructions, which when executed, cause the computer to perform the operations of the method for managing visitor information provided by any of the above embodiments.

An embodiment of the present disclosure further provides another computer program, including computer readable codes, wherein when the computer readable codes are run in an electronic device, the operations of the method for managing visitor information provided by any of the above embodiments are performed by a processor in the electronic device.

The electronic device can be provided as a terminal device, a server or other form of devices.

Without violating logic, different embodiments of the present disclosure can be combined with each other, and the description of different embodiments has some emphasis, and the parts that are not described can refer to the records of other embodiments.

In some embodiments of the present disclosure, functions or the included modules of the apparatus provided in the embodiments of the present disclosure may be used to perform the method described in the above method embodiments. For specific implementation and technical effects, please refer to the above method embodiments. For brevity, details are not described herein again.

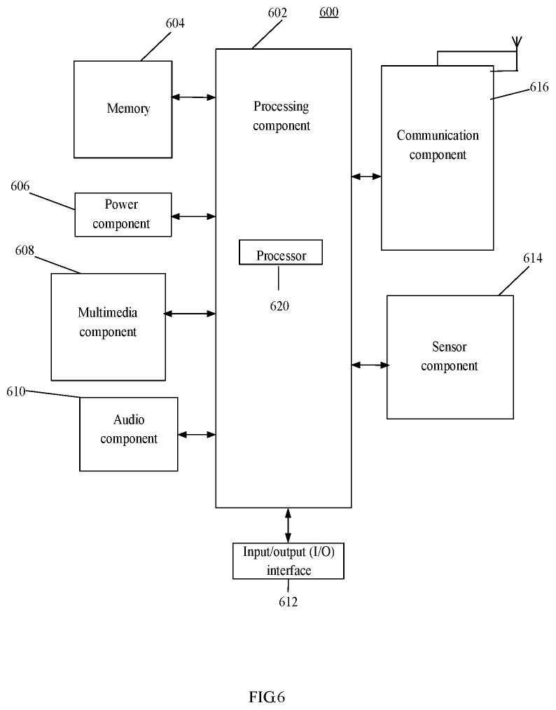

FIG. 6 illustrates a block diagram of an electronic device 600 according to embodiments of the present disclosure. For example, the electronic device 600 can be a mobile phone, a computer, a digital broadcast terminal, a message transmitting and receiving device, a gaming console, a tablet device, a medical device, a fitness device, a personal digital assistant, and the like terminal.

Referring to FIG. 6, the electronic device 600 can include one or more of the following components: processing component 602, memory 604, power component 606, multimedia component 608, audio component 610, input/output (I/O) interface 612, sensor component 614, and a communication component 616.

Processing component 602 typically controls the overall operation of the electronic device 600, such as operations associated with display, telephone calls, data communications, camera operations, and recording operations. Processing component 602 can include one or more processors 620 to execute instructions to perform all or part of the steps described above. Moreover, processing component 602 can include one or more modules to facilitate interaction between component 602 and other components. For example, processing component 602 can include a multimedia module to facilitate interaction between multimedia component 608 and processing component 602.

The memory 604 is to store various types of data to support the operation of the electronic device 600. Examples of such data include instructions for any application or method operating on the electronic device 600, contact data, phone book data, messages, pictures, videos, and the like. The memory 604 can be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, disk or optical Disk.

Power component 606 provides power to various components of the electronic device 600. Power component 606 can include a power management system, one or more power sources, and other components associated with generating, managing, and distributing power for the electronic device 600.

The multimedia component 608 includes a screen between the electronic device 600 and the user that provides an output interface. In some examples, the screen can include a liquid crystal display (LCD) and a touch panel (TP). If the screen includes a touch panel, the screen can be implemented as a touch screen to receive input signals from the user. The touch panel includes one or more touch sensors to sense touches, swipes, and gestures on the touch panel. The touch sensor may sense not only the boundary of the touch or sliding action, but also the duration and pressure associated with the touch or slide operation. In some examples, the multimedia component 608 includes a front camera and/or a rear camera. The front camera and/or rear camera may receive external multimedia data when the electronic device 600 is in an operating mode, such as a photographing mode or a video mode. Each front and rear camera can be a fixed optical lens system or have focal length and optical zoom capabilities.

The audio component 610 is configured to output and/or input an audio signal. For example, audio component 610 includes a microphone (MIC) that is configured to receive an external audio signal when the electronic device 600 is in an operational mode, such as a call mode, a recording mode, and a voice recognition mode. The received audio signal may be further stored in memory 604 or transmitted via communication component 616. In some examples, audio component 610 also includes a speaker for outputting an audio signal.

The I/O interface 612 may provide interfaces between the processing component 602 and peripheral interface modules. The peripheral interface modules may include a keyboard, a click wheel, buttons and so on. These buttons may include, but are not limited to, a home button, a volume button, a start button, and a lock button.

Sensor component 614 includes one or more sensors for providing electronic device 600 with a status assessment of various aspects. For example, the sensor component 614 may detect the on/off status of the electronic device 600, and relative positioning of component, for example, the component is a display and a keypad of the electronic device 600. The sensor component 614 may also detect a change in position of the electronic device 600 or a component of the electronic device 600, a presence or absence of the contact between a user and the electronic device 600, an orientation or an acceleration/deceleration of the electronic device 600, and a change in temperature of the electronic device 600. Sensor component 614 can include a proximity sensor configured to detect the presence of nearby objects without any physical contact. Sensor component 614 may also include a light sensor, such as a complementary metal oxide semiconductor (CMOS) or charge-coupled device (CCD) image sensor, for use in imaging applications. In some embodiments, the sensor component 614 can also include an acceleration sensor, a gyro sensor, a magnetic sensor, a pressure sensor, or a temperature sensor.

Communication component 616 is configured to facilitate wired or wireless communication between the electronic device 600 and other devices. The electronic device 600 can access a wireless network based on a communication standard, such as wireless network (WiFi), second generation mobile communications technology (2G) or third generation mobile communications technology (3G), or a combination thereof. In an exemplary example, communication component 616 receives broadcast signals or broadcast associated information from an external broadcast management system via a broadcast channel. In an exemplary example, the communication component 616 also includes a near field communication (NFC) module to facilitate short range communication. For example, the NFC module can be implemented based on radio frequency identification (RFID) technology, infrared data association (IrDA) technology, ultra-wideband (UWB) technology, Bluetooth (BT) technology, and other technologies.

In an exemplary example, the electronic device 600 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic elements for performing the method described in any of the above examples.

In an exemplary example, there is also provided a non-transitory computer readable storage medium including instructions, such as a memory 604 including instructions executable by processor 620 of the electronic 600 to perform the above method.

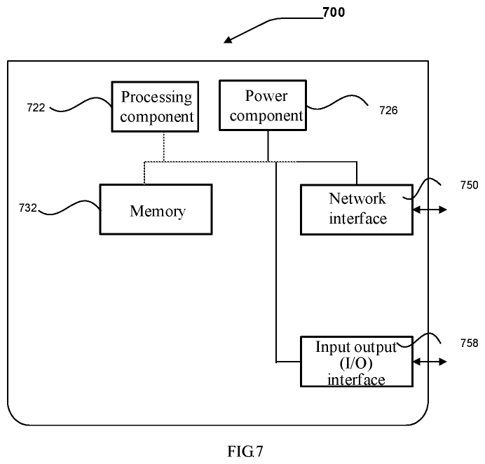

FIG. 7 illustrates a block diagram of an electronic device 700 according to embodiments of the present disclosure. For example, the electronic device 700 may be provided as a server. Referring to FIG. 7, the electronic device 700 includes a processing component 722, which further includes one or more processors, and memory resources indicate by the memory 732 for storing instructions executable by the processing component 722, such as application programs. The application programs stored in the memory 732 may include one or more modules each corresponding to a set of instructions. In addition, the processing component 722 is configured to execute instructions to perform the above-described methods.

The electronic device 700 may also include a power component 726 configured to perform power management of the electronic device 700, a wired or wireless network interface 750 configured to connect the electronic device 700 to the network, and an input output (I/O) interface 758. The electronic device 700 can operate based on an operating system stored in the memory 732, such as Microsoft server operating system (Windows Server™), Apple's GUI-based operating system (Mac OS X™), multi-user multi-process computer operating system (Unix™), free and open source Unix-like operating system (Linux™), open source Unix-like operating system (FreeBSD™) or the like.

In an exemplary embodiment, a non-volatile computer-readable storage medium is also provided, such as the memory 732 including computer program instructions, which can be executed by the processing component 722 of the electronic device 700 to implement the above methods.

The present disclosure can be a system, method and/or computer program product. The computer program product may include a computer-readable storage medium storing computer-readable program instructions thereon for causing a processor to implement various aspects of the present disclosure.

The computer-readable storage medium may be a tangible device that can maintain and store instructions for an instruction execution device. The computer-readable storage medium may be, for example, but not limited to, an electrical storage device, a magnetic storage device, an optical storage device, an electromagnetic storage device, a semiconductor storage device, or any suitable combination of the above. More specific examples of computer-readable storage media (non-exhaustive list) include: portable computer disk, hard disk, random access memory (RAM), read-only memory (ROM), erasable programmable read-only memory ((EPROM) or flash memory), static random access memory (SRAM), portable compact disk read-only memory (CD-ROM), digital versatile disk (DVD), memory stick, floppy disk, a mechanically encoded device such as punch-cards or raised structures in a groove having instructions recorded thereon, and any suitable combination of the above. The computer-readable storage medium used here is not interpreted as a transient signal itself, such as radio waves or other freely propagating electromagnetic waves, electromagnetic waves propagating through waveguides or other transmission media (for example, light pulses through fiber optic cables), or electrical signals transmitted through wires.

The computer-readable program instructions described herein can be downloaded from a computer-readable storage medium to various computing/processing devices, or downloaded to an external computer or external storage device via a network, such as the Internet, a local area network (LAN), a wide area network (WAN), and/or a wireless network. The network may include copper transmission cables, optical fiber transmission, wireless transmission, routers, firewalls, switches, gateway computers, and/or edge servers. The network adapter card or network interface in each computing/processing device receives computer-readable program instructions from the network, and forwards the computer-readable program instructions for storage in the computer-readable storage medium in each computing/processing device.

The computer-readable program instructions for carrying out the above-described methods may be assembler instructions, instruction-set-architecture (ISA) instructions, machine instructions, machine dependent instructions, microcode, firmware instructions, state-setting data, or source code or object code written in any combination of one or more programming languages, including an object oriented programming language such as Smalltalk, C++ and the like, and conventional procedural programming languages such as “C” language and the like. The computer-readable program instructions can be executed entirely on the user's computer, partly on the user's computer, executed as a stand-alone software package, executed partly on the user's computer and partly on a remote computer, or entirely on the remote computer or server. In the case that involves the remote computer, the remote computer can be connected to the user's computer through any kind of network, including a local area network or a wide area network, or it can be connected to an external computer (for example, using an Internet service provider to access the Internet connection). In some embodiments, an electronic circuit, such as a programmable logic circuit, a field programmable gate array (FPGA), or a programmable logic array (PLA), can be customized by using the status information of the computer-readable program instructions. The computer-readable program instructions are executed to realize various aspects of the present disclosure.

Here, various aspects of the present disclosure are described with reference to the flowcharts and/or block diagrams of the methods, devices (systems) and computer program products according to the embodiments of the present disclosure. It should be understood that each block of the flowcharts and/or block diagrams and combinations of blocks in the flowcharts and/or block diagrams can be implemented by computer-readable program instructions.

These computer-readable program instructions can be provided to the processor of a general-purpose computer, a special-purpose computer, or other programmable data processing device, thereby producing a machine such that when these instructions are executed by the processor of the computer or other programmable data processing device, A device that implements the functions/actions specified in one or more blocks in the flowchart and/or block diagram is produced. It is also possible to store these computer-readable program instructions in a computer-readable storage medium. These instructions make computers, programmable data processing apparatuses, and/or other devices work in a specific manner, so that the computer-readable medium storing instructions includes an article of manufacture, which includes instructions for implementing various aspects of the functions/actions specified in one or more blocks in the flowchart and/or block diagram.

It is also possible to load computer-readable program instructions on a computer, other programmable data processing device, or other equipment, so that a series of operation steps are implemented on the computer, other programmable data processing device, or other equipment to produce a computer-implemented process , So that the instructions executed on the computer, other programmable data processing apparatus, or other equipment realize the functions/actions specified in one or more blocks in the flowcharts and/or block diagrams.

The flowcharts and block diagrams in the drawings show the possible implementation of the system architecture, functions, and operations of the system, method, and computer program product according to multiple embodiments of the present disclosure. In this regard, each block in the flowchart or block diagram may represent a module, program segment, or part of an instruction, and the module, program segment, or part of an instruction contains one or more functions for implementing the executable instructions of specified logical functions. In some alternative embodiments, the functions marked in the block may also occur in a different order from the order marked in the drawings. For example, two consecutive blocks can actually be implemented in parallel, or they can sometimes be implemented in the reverse order, depending on the functions involved. It should also be noted that each block in the block diagram and/or flowchart, and the combination of the blocks in the block diagram and/or flowchart, can be implemented by a dedicated hardware-based system that performs the specified functions or actions or it can be realized by a combination of dedicated hardware and computer instructions.

The computer program product may be specifically implemented by hardware, software, or a combination thereof. In an optional embodiment, the computer program product is embodied as a computer storage medium, and in another optional embodiment, the computer program product is embodied as a software product, for example, a software development kit (SDK), etc.

The embodiments of the present disclosure have been described above, and the above description is exemplary and not exhaustive, and is not limited to the disclosed embodiments. Without departing from the scope and spirit of the described embodiments, many modifications and changes are obvious to those of ordinary skill in the art. The choice of terms used herein is intended to best explain the principles, practical applications, or improvements of the technologies in the market, or to enable other ordinary skilled in the art to understand the embodiments disclosed herein.

1. A method for managing visitor information, comprising:
receiving a follow-up request for a target visitor by a client-side computing system, wherein the target visitor is included in unfollowed-up visitors in a visitor list;
obtaining information of accompanying persons of the target visitor from a server-side computing system in response to the follow-up request by the client-side computing system;
establishing a visitor group including the target visitor based on the target visitor and the accompanying persons of the target visitor to associate information of multiple visitors in the visitor group by the client-side computing system; and
displaying the information of multiple visitors in the visitor group by the client-side computing system.

2. The method according to claim 1, wherein establishing the visitor group including the target visitor based on the target visitor and the accompanying persons of the target visitor comprises:
displaying the information of the accompanying persons of the target visitor by the client-side computing system; and
in response to a first operation of selecting a target accompanying person from the accompanying persons of the target visitor, adding the target accompanying person to the visitor group by the client-side computing system.

3. The method according to claim 1, wherein establishing the visitor group including the target visitor based on the target visitor and the accompanying persons of the target visitor comprises:
adjusting the visitor group for the target visitor according to visit data of the unfollowed-up visitors in the visitor list.

4. The method according to claim 3, wherein adjusting the visitor group for the target visitor according to the visit data of the unfollowed-up visitors in the visitor list comprises:
displaying information of the unfollowed-up visitors in the visitor list by the client-side computing system; and
in response to a second operation of selecting a target unfollowed-up visitor, adding the target unfollowed-up visitor to the visitor group by the client-side computing system.

5. The method according to claim 4, wherein displaying the information of the unfollowed-up visitors in the visitor list by the client-side computing system comprises:
obtaining visit time of the unfollowed-up visitors in the visitor list from the server-side computing system; and
displaying the information of the unfollowed-up visitors in the visitor list according to the visit time of the unfollowed-up visitors by the client-side computing system,
wherein the unfollowed-up visitors in the visitor list are arranged according to at least one of the visit time of the unfollowed-up visitors or a similarity between the visit time of the unfollowed-up visitors and a visit time of the target visitor.

6. The method according to claim 1, wherein, after establishing the visitor group including the target visitor based on the target visitor and the accompanying persons of the target visitor, the method further comprises:
determining a decision maker in the visitor group according to visit data of at least one visitor in the visitor group by the client-side computing system.

7. The method according to claim 6, wherein the decision maker comprises at least one of:
a visitor in the visitor group with a visit frequency greater than a first threshold,
a visitor in the visitor group with a recorded visitor data volume greater than a second threshold, or
a visitor in the visitor group with a number of visits greater than a third threshold.

8. The method according to claim 1, wherein the accompanying persons of the target visitor are determined by the server-side computing system according to trajectory information of multiple persons, and
wherein the server-side computing system is configured to:
perform a person detection on video images captured by a plurality of image capturing devices deployed in different regions to obtain a person detection result;
determine an image set corresponding to at least one of the multiple persons based on a result of performing the person detection, wherein the image set corresponding to the at least one of the multiple persons comprises a person image of the at least one of the multiple persons; and
determine trajectory information of the at least one of the multiple persons according to position information of the plurality of image capturing devices, the image set corresponding to the at least one of the multiple persons, and a time at which the person image is captured.

9. The method according to claim 8, wherein the server-side computing system is configured to determine the accompanying persons of the target visitor according to the trajectory information of the multiple persons by:
clustering the trajectory information of the multiple persons to obtain a cluster set including trajectory information of the target visitor; and
determining persons corresponding to multiple groups of trajectory information in the cluster set as a group of accompanying persons.

10. The method according to claim 8, wherein the server-side computing system is configured to determine the trajectory information of the at least one person by:
for at least one person image in the image set corresponding to the at least one of the multiple persons, determining first position information of a target person in the at least one person image in video images corresponding to the at least one person image;
determining a spatial position coordinate of the target person in a spatial coordinate system based on the first position information and second position information, wherein the second position information is position information of image capturing devices for capturing the video images corresponding to the at least one person image;
obtaining a spatiotemporal position coordinate of the target person in a spatiotemporal coordinate system according to the spatial position coordinate and time when the video images corresponding to the at least one person image are captured; and
obtaining the trajectory information of the at least one of the multiple persons in the spatiotemporal coordinate system based on spatiotemporal position coordinates of the multiple persons.

11. The method according to claim 10, wherein the trajectory information of the at least one of the multiple persons comprises point groups in the spatiotemporal coordinate system, and
wherein the server-side computing system is configured to determine the accompanying persons of the target visitor according to the trajectory information of the multiple persons by:
for each two persons of the multiple persons, determining a similarity for point groups corresponding to the two persons in the spatiotemporal coordinate system in the trajectory information of the multiple persons;
determining multiple person pairs based on a comparison between the similarity and a first similarity threshold, wherein each of the multiple person pairs includes two persons, and a value of the similarity of each of the multiple person pairs is greater than the first similarity threshold; and
determining the accompanying persons of the target visitor based on the multiple person pairs.

12. The method according to claim 11, wherein the server-side computing system is configured to determine the accompanying persons of the target visitor based on the multiple person pairs by:
establishing an accompanying person set based on a first person pair in the multiple person pairs, wherein the first person pair comprises the target visitor;
determining an associated person pair from at least one second person pair of the multiple person pairs other than a person pair included in the accompanying person set, wherein the associated person pair comprises at least one person in the accompanying person set;
adding the associated person pair into the accompanying persons set; and
determining persons other than the target visitor in the accompanying person set as the accompanying persons of the target visitor.

13. The method according to claim 12, wherein the server-side computing system is configured to add the associated person pair into the accompanying person set by:
determining a number of person pairs including a first person in the associated person pair; and
in response to determining that the number of person pairs including the first person is less than a person pair number threshold, adding the associated person pair into the accompanying person set.

14. The method according to claim 11, wherein, after determining the accompanying persons of the target visitor based on the multiple person pairs, the server-side computing system is further configured to:
in response to determining that a number of persons in the accompanying persons of the target visitor is greater than a first number threshold, determine at least one of the multiple person pairs with a similarity greater than a second similarity threshold to be a group of accompanying persons, such that the number of persons in the group of accompanying persons is less than the first number threshold, wherein the second similarity threshold is greater than the first similarity threshold.

15. The method according to claim 11, wherein the server-side computing system is configured to, for each two persons of the multiple persons, determine the similarity for the point groups corresponding to the two persons in the spatiotemporal coordinate system in the trajectory information of the multiple persons by:
for a first person and a second person in the two persons, determining a spatial distance between at least one first spatiotemporal position coordinate corresponding to the first person in the spatiotemporal coordinate system and at least one second spatiotemporal position coordinate corresponding to the second person in the spatiotemporal coordinate system;
determining a first number of first spatiotemporal position coordinates corresponding to the spatial distance less than or equal to a distance threshold, and a second number of second spatiotemporal position coordinates corresponding to the spatial distance less than or equal to the distance threshold;
determining a first ratio of the first number to a total number of the at least one first spatiotemporal position coordinate, and a second ratio of the second number to a total number of the at least one second spatiotemporal position coordinate; and
determining a maximum value of the first ratio and the second ratio as the similarity of the two persons.

16. A system, comprising:
at least one processor; and
one or more memories coupled to the at least one processor and storing programming instructions for execution by the at least one processor to perform operations comprising:
receiving a follow-up request for a target visitor, wherein the target visitor is included in unfollowed-up visitors in a visitor list;
obtaining information of accompanying persons of the target visitor from a server-side computing system in response to the follow-up request;
establishing a visitor group including the target visitor based on the target visitor and the accompanying persons of the target visitor to associate information of multiple visitors in the visitor group; and
displaying the information of multiple visitors in the visitor group.

17. The system according to claim 16, wherein establishing the visitor group including the target visitor based on the target visitor and the accompanying persons of the target visitor comprises:
displaying the information of accompanying persons of the target visitor; and
in response to a first operation of selecting a target accompanying person from the accompanying persons of the target visitor, adding the target accompanying person to the visitor group.

18. The system according to claim 16, wherein establishing the visitor group including the target visitor based on the target visitor and the accompanying persons of the target visitor comprises:
adjusting the visitor group for the target visitor according to visit data of the unfollowed-up visitors in the visitor list.

19. The system according to claim 18, wherein adjusting the visitor group for the target visitor according to the visit data of the unfollowed-up visitors in the visitor list comprises:
displaying information of the unfollowed-up visitors in the visitor list; and
in response to a second operation of selecting a target unfollowed-up visitor, adding the target unfollowed-up visitor to the visitor group.

20. A non-transitory computer-readable storage medium coupled to at least one processor having machine-executable instructions stored thereon that, when executed by the at least one processor, cause the at least one processor to perform operations comprising:
receiving a follow-up request for a target visitor, wherein the target visitor is included in unfollowed-up visitors in a visitor list;
obtaining accompanying persons of the target visitor from a server-side computing system in response to the follow-up request;
establishing a visitor group including the target visitor based on the target visitor and the accompanying persons of the target visitor to associate information of multiple visitors in the visitor group; and
displaying the information of multiple visitors in the visitor group.
